(19) United States
(12) Patent Application Publication
(10) Pub. No.: US 2019/0026689 A1
(43) Pub. Date: Jan. 24, 2019

(54) DATA WAREHOUSE FOR A COLD CHAIN SYSTEM

(71) Applicant: Carrier Corporation, Palm Beach Gardens, FL (US)

(72) Inventors: James J. Minard, Roscoe, IL (US); Ciara Poolman, Syracuse, NY (US); Robert A. Chopko, Baldwinsville, NY (US); Renee A. Eddy, Manlius, NY (US)

(21) Appl. No.: 16/069,541

(22) PCT Filed: Jan. 13, 2017
(86) PCT No.: PCT/US2017/013315

§ 371 Date: Jul. 12, 2018

Related U.S. Application Data
(60) Provisional application No. 62/279,261, filed on Jan. 15, 2016.

(51) Int. Cl. G06Q 10/08; G06F 17/30

(52) U.S. Cl. CPC G06Q 10/087; G06F 17/30371

(57) ABSTRACT

A method and system to provide at least one product record for a product to a user includes at least one cold chain information source to provide at least one product information entry for the product, a data warehouse, including a processor to receive and analyze the at least one product information entry from the at least one cold chain information source, and to assemble the at least one product record from the at least one product information entry, wherein the at least one product record includes a product fingerprint with a traceability entry, and a product database to store the at least one product record, and at least one user system to provide the user access to the at least one product record.

### DESCRIPTION OF RELATED ART

The subject matter disclosed herein relates to providing a product record to a user, and to a system and a method for providing a product record with information from multiple sources to a user

Typically, cold chain distribution systems are used to transport and distribute temperature sensitive and perishable goods. For example, products such as food and pharmaceuticals may be susceptible to temperature, humidity, contaminants, and other environmental factors. Advantageously, cold chain systems allow perishable and environmentally sensitive goods to be effectively transported and distributed without damage or other undesirable effects.

Various portions within the cold chain distribution system may be isolated devices or systems. Accordingly, various portions of the cold chain distribution system may operate or log data without communication with other portions of the cold chain distribution system and therefore may not provide comprehensive information about products. A system and method that can provide a product record with information from multiple sources to a user is desired.

### BRIEF SUMMARY

According to an embodiment, a system to provide at least one product record for a product to a user includes at least one cold chain information source to provide at least one product information entry for the product, a data warehouse, including a processor to receive and analyze the at least one product information entry from the at least one cold chain information source, and to assemble the at least one product record from the at least one product information entry, wherein the at least one product record includes a product fingerprint with a traceability entry, and a product database to store the at least one product record, and at least one user system to provide the user access to the at least one product record.

In addition to one or more of the features described above, or as an alternative, further embodiments could include that the processor identifies a missing product information entry from the at least one product record.

In addition to one or more of the features described above, or as an alternative, further embodiments could include that the at least one cold chain information source includes at least one of a grower information system, a transportation information system, a tracking information system, a warehousing information system, and an inventory information system.

In addition to one or more of the features described above, or as an alternative, further embodiments could include that the inventory information system includes a plurality of product scanners to determine a product inventory level.

In addition to one or more of the features described above, or as an alternative, further embodiments could include that the at least one product information entry includes at least one of a product origin entry, a transport time entry, an environmental exposure entry, and a usage information entry.

In addition to one or more of the features described above, or as an alternative, further embodiments could include that the at least one user system includes a relationship management system.

In addition to one or more of the features described above, or as an alternative, further embodiments could include that the relationship management system includes a profile database containing at least one customer profile record.

In addition to one or more of the features described above, or as an alternative, further embodiments could include that the at least one customer profile record includes at least one of a customer priority entry, a desired product entry, a customer feedback entry, and a customer buying pattern entry.

In addition to one or more of the features described above, or as an alternative, further embodiments could include that the relationship management system notifies the user in response to the at least one customer profile record corresponding to at least one product record.

In addition to one or more of the features described above, or as an alternative, further embodiments could include that the relationship management system receives a feedback parameter corresponding to the at least one product record.

According to an embodiment, a method to provide at least one product record for a product to a user includes providing at least one product information entry for the product via the at least one cold chain information source, receiving the at least one product information entry for the product from the at least one cold chain information source via a processor, analyzing the at least one product information entry for the product from the at least one cold chain information source via the processor, assembling the at least one product record from the at least one product information entry via the processor, wherein the at least one product record includes a product fingerprint with a traceability entry, storing the at least one product record via a product database, and providing the user access to the at least one product record via at least one user system.

In addition to one or more of the features described above, or as an alternative, further embodiments could include identifying a missing product information entry from the at least one product record via the processor.

In addition to one or more of the features described above, or as an alternative, further embodiments could include that the at least one user system includes a relationship management system.

In addition to one or more of the features described above, or as an alternative, further embodiments could include that the relationship management system includes a profile database containing at least one customer profile record.

In addition to one or more of the features described above, or as an alternative, further embodiments could include notifying the user in response to the at least one customer profile record corresponding to at least one product record via the relationship management system.

Technical function of the embodiments described above includes a processor to receive and analyze the at least one product information entry from the at least one cold chain information source, and to assemble the at least one product record from the at least one product information entry, wherein the at least one product record includes a product fingerprint with a traceability entry and at least one user system to provide the user access to the at least one product record.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 illustrates a schematic view of a product information system; and

FIG. 2 is a flow diagram of a method of providing at least one product record for a product to a user.

### DETAILED DESCRIPTION

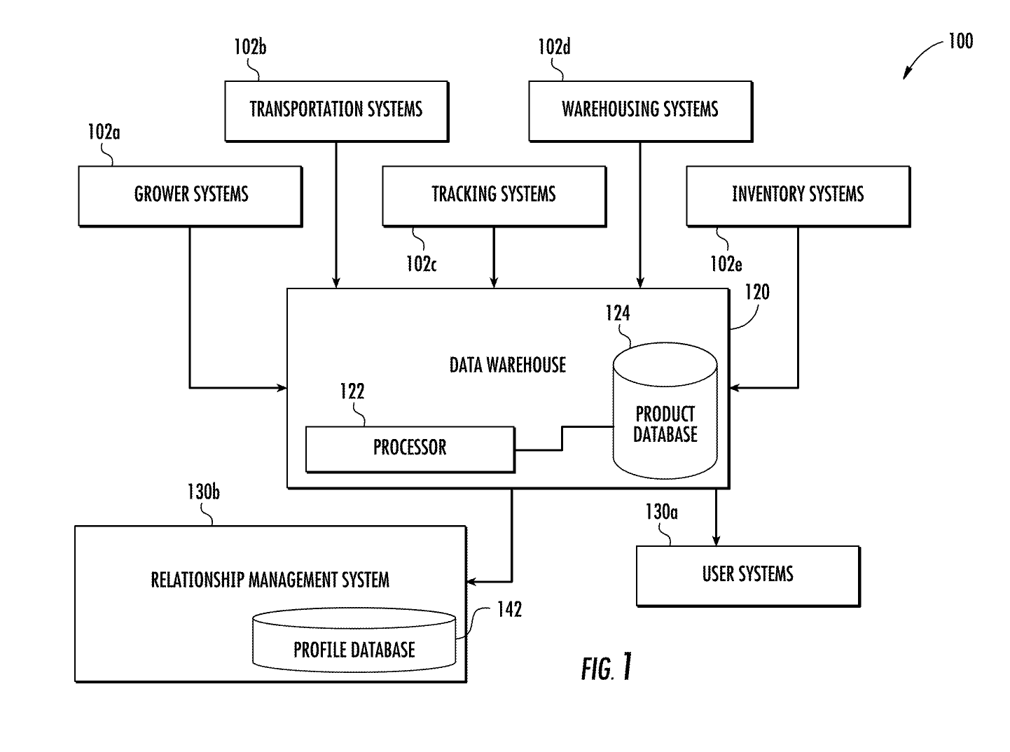

Referring now to the drawings, FIG. 1 illustrates a schematic view of the product information system 100. In the illustrated embodiment, the product information system 100 includes at least one cold chain information source 102a-120e, a data warehouse 120, and at least one user system 130a,130b. In the illustrated embodiment, the product information system 100 can be used to provide product information to a user. Advantageously, the product information system 100 can provide comprehensive information regarding the products from all aspects of the cold chain distribution system. In certain embodiments, the user can receive a “product fingerprint” that provides information to provide “farm to fork” traceability. Further, in certain embodiments, the comprehensive product information can be utilized to operate lean or just in time production methods such as Kanban production methods.

In the illustrated embodiment, the cold chain information sources 102a-102e can include, but are not limited to, grower information systems 102a, transportation information systems 102b, tracking information systems 102c, warehousing information systems 102d, and inventory information systems 102e. In the illustrated embodiment, the product information system 100 can include any suitable type and number of cold chain information sources not limited to those described herein. In the illustrated embodiment, the cold chain information sources 102a-102e can be isolated cold chain information sources, while in other embodiments, the cold chain information sources 102a-102e may be interconnected. In the illustrated embodiment, the cold chain information sources 102a-102e can each provide isolated or otherwise unassociated product information entries relevant to the product within the cold chain distribution system. In the illustrated embodiment, the product information entries can include, but are not limited to, temperatures, humidity levels, ethylene levels, shock values, excursions beyond prescribed parameters, excursion duration, etc.

In the illustrated embodiment, the product information system 100 includes a grower information system 102a. In the illustrated embodiment, the grower information system 102a can supply information from the grower to the data warehouse 120. In certain embodiments, the grower can supply initial information about the product such as the type, quality, quantity, etc. of the product being distributed within the cold chain distribution system. In certain embodiments, the grower information system 102a can provide product information entries regarding the temperature of the product as the products are picked up for distribution, if the products were refrigerated while awaiting pick up, etc.

In the illustrated embodiment, the product information system 100 includes a transportation information system 102b. In the illustrated embodiment, the transportation information system 102b can provide information received during transport to the data warehouse 120. Product information entries from the transportation information system 102b can include, but are not limited to, refrigeration conditions in the trailer such as temperature, humidity, etc. In the illustrated embodiment, the transportation information system 102b can further provide additional transportation parameters, include transport time, temperature excursions and durations thereof, if the trailer door has been opened and durations thereof.

In the illustrated embodiment, the product information system 100 can further include a tracking information system 102c. In the illustrated embodiment, the tracking information system 102c can include GPS position data independent from the transportation information system 102b. Further, the tracking information system 102c can further provide climate data both within the cold chain and outside of the containers. In certain embodiments, outside temperature data may be used to determine a door open condition, etc. affect the quality of the product. In certain embodiments, the information from multiple systems such as the transportation information system 102b and the tracking information system 102c can be used to cross check data. Further, in certain embodiments, the tracking information system 102c can utilize embedded or dedicated sensors that are associated with the product to travel with the product for the entire duration of the distribution.

In the illustrated embodiment, the product information system 100 includes a warehousing information system 102d. In the illustrated embodiment, the warehousing information system 102d can provide information entries regarding the reception and storage of a product. For example, the warehousing information system 102d can provide information entries regarding the time of receipt of a product from a climate controlled container, if the product was left outside of a climate controlled area, and a duration thereof. Further information can include the ambient dock temperature, ambient humidity, etc.

In the illustrated embodiment, the product information system 100 includes an inventory information system 102e. In the illustrated embodiment, the inventory information system 102e can provide a product location, a product age, a product temperature, a product humidity, etc. In the illustrated embodiment, the inventory information system 102e can provide product aging information to determine the best time to distribute a product to allow the product to arrive at a desired time or a desired condition such as desired ripeness, etc. In certain embodiments, the inventory information system 102e can utilize an input scanner and an output scanner. In certain embodiments, scanners can be utilized to identify when a product enters an inventory and when the product exits an inventory. In certain embodiments, these scanners can be disposed on opposite ends of a hopper containing the product of interest.

In the illustrated embodiment, the data warehouse 120 includes a processor 122 and a product database 124. The data warehouse 120 can receive product information entries from various cold chain information sources 102a-102e, assemble the product information entries into product information records, and analyze the product information entries to determine related information. Advantageously, the data warehouse 120 can assemble information that is typically only available from various cold chain information sources to provide a “product fingerprint” regarding the product to the user. In certain embodiments, the “product fingerprint” includes traceability entries that provide information regarding the product as the product is transported within the cold chain. Traceability entries can be information created or formed after analyzing individual product entries from the cold chain information sources 102a-102e and transforming the individual product entries into a simplified and consolidated traceability entry.

In the illustrated embodiment, the processor 122 can receive product information entries from the plurality of cold chain information sources 102a-102e. In the illustrated embodiments, the processor 122 can initiate a product information record with product information entries received from the grower information system 102a. In the illustrated embodiment, additional information can be populated from additional information systems 102b-102e as products are distributed within the cold chain distribution system.

In the illustrated embodiment, the processor 122 can assemble the product information entries into product information records. The product information records can be stored in a product database 124. In the illustrated embodiment the product database 124 can be a local repository, a cloud based storage, a remote server, etc. In the illustrated embodiment, the product database 124 can be a centralized location to store relevant information about the products from the various cold chain information sources 102a-102e.

In certain embodiments, the processor 122 can analyze the product information records. The processor 122 can execute routines or algorithms to identify and relate product information entries from various cold chain information sources 102a-102e. For example, temperature information from a cold chain information source can be associated with GPS tracking information from another cold chain information source. Further, in another example, timing data between the transportation information system 102b and the warehousing information system 102d can be reconciled to determine how long products may have been outside a warehouse or other climate controlled area. In certain embodiments, the processor 122 can analyze external factors such as the desired or intended user of the product.

In the illustrated embodiment, the processor 122 can analyze the product information records to identify missing product information entries. These product information entries may be considered gaps or data that is desired to be present. In certain embodiments, the product information entries can be interpreted or inferred from other data that is available to create estimates or approximations of location data, temperature data, etc.

In the illustrated embodiment, the assembled information records can be utilized by user systems 130a. The user systems 130a can communicate the product information records to the user to facilitate decisions regarding the products. In certain embodiments, the intended user can be a supermarket, restaurant or other final provider of the product. In other embodiments, the intended user can be the consumer of a product such as a restaurant customer, supermarket customer, etc. In the illustrated embodiment, the user system 130a can be a phone application, a computer application, a website, a social media application, etc.

In certain embodiments, the assembled product information records can be utilized by a relationship management system 130b. In the illustrated embodiment, the relationship management system 130b can be used to provide notifications and customer contact in response to the product information records or inventory corresponding to customer profiles.

In the illustrated embodiment, the profile database 142 can contain customer information profiles containing customer profile entries such as customer priority, desired products, customer feedback, and customer buying patterns. For example, a customer priority entry may include information regarding the priority of the customer to the business or establishment, classifying them as an A-level customer, B-level customer, etc. In certain embodiments, priority levels may be determined by metrics such as a spending level, or a number of customer visits, etc. A desired products entry may indicate products that a customer may desire either through expressed interest or observed interest. In certain embodiments, the customer information profile can include customer feedback entries either entered by the customer or via feedback received from employees. A customer buying pattern entry can utilize customer reported or observed, forecasted, or estimated buying patterns to gather customer information.

In the illustrated embodiment, the customer information profiles can be analyzed in light of the information received from the product information records from the data warehouse 120. For example, the customer information profiles can be analyzed to determine and forecast products customers may desire. In certain embodiments, information from the product information records can be utilized to identify if such a desired product is in stock or en route to be in stock. In certain embodiments, the product information records can be analyzed to be determined if a desired product with a desired product freshness, temperature, origin or other overall quality is in stock or en route to be in stock. Further if “special” or otherwise highly desirable items are in stock or en route to be in stock a customer can be contacted based on a customer priority level. In other embodiments, general announcements can be made to customers in response to certain products or product characteristics, such as fresh items or specials to clear inventory. In certain embodiments, the relationship management system 130b can directly contact customers while in other embodiments, the relationship management system 130b can prompt or notify employees to notify customers as needed. In certain embodiments, the relationship management system 130b can receive feedback parameters from customers to indicate a customer desire or interest (yes or no) to reserve or purchase certain products.

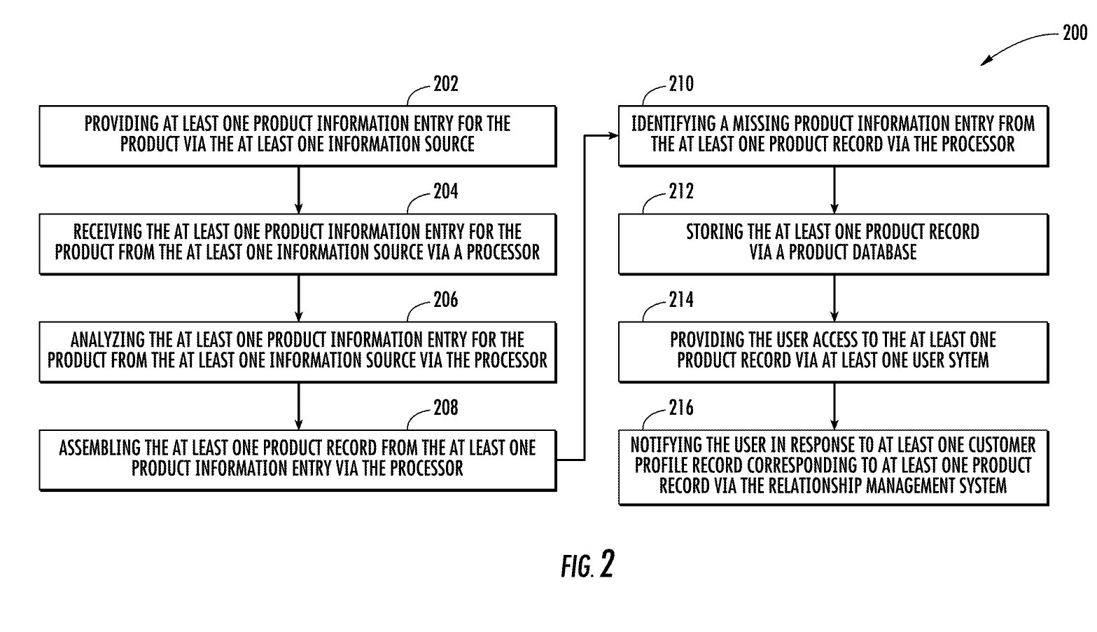

Referring to FIG. 2, a method 200 for providing at least one product record for a product for a user is described. In operation 202, at least one product information entry for the product is provided via the at least one cold chain information source. In the illustrated embodiment, the cold chain information sources can include, but are not limited to, grower information systems, transportation information systems, tracking information systems, warehousing information systems, and inventory information systems. In the illustrated embodiment, the product information system can include any suitable type and number of cold chain information sources not limited to those described herein.

In operation 204, the at least one product information entry for the product is received from the at least one cold chain information source via a processor. In the illustrated embodiments, the processor can initiate a product information record with product information entries received from the grower information system. In the illustrated embodiment, additional information can be populated from additional information systems as products are distributed within the cold chain distribution system.

In operation 206, the at least one product information entry for the product from the at least one cold chain information source is analyzed via the processor. The processor can execute routines or algorithms to identify and relate product information entries from various cold chain information sources. In certain embodiments, the processor can analyze external factors such as the desired or intended user of the product.

In operation 208, the at least one product record from the at least one product information entry is assembled via the processor. In operation 210, a missing product information entry from the at least one product record is identified via the processor. These product information entries may be considered gaps or data that is desired to be present. In certain embodiments, the product information entries can be interpreted or inferred from other data that is available to create estimates or approximations of location data, temperature data, etc. In operation 212, the at least one product record is stored via a product database.

In operation 214, the user access to the at least one product record is provided via at least one user system. The user systems can communicate the product information records to the user to facilitate decisions regarding the products. In certain embodiments, the intended user can be a supermarket, restaurant or other final provider of the product. In other embodiments, the intended user can be the consumer of a product such as a restaurant customer, supermarket customer, etc.

In operation 216, the user is notified in response to the at least one customer profile record corresponding to at least one product record via the relationship management system. In the illustrated embodiment, the relationship management system can be used to provide notifications and customer contact in response to the product information records or inventory corresponding to customer profiles.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

1. A system to provide at least one product record for a product to a user, the system comprising:
at least one cold chain information source to provide at least one product information entry for the product;
a data warehouse, comprising:
a processor to receive and analyze the at least one product information entry from the at least one cold chain information source, and to assemble the at least one product record from the at least one product information entry, wherein the at least one product record includes a product fingerprint with a traceability entry; and
a product database to store the at least one product record; and
at least one user system to provide the user access to the at least one product record.

2. The system of claim 1, wherein the processor identifies a missing product information entry from the at least one product record.

3. The system of claim 1, wherein the at least one cold chain information source includes at least one of a grower information system, a transportation information system, a tracking information system, a warehousing information system, and an inventory information system.

4. The system of claim 3, wherein the inventory information system includes a plurality of product scanners to determine a product inventory level.

5. The system of claim 1, wherein the at least one product information entry includes at least one of a product origin entry, a transport time entry, an environmental exposure entry, and a usage information entry.

6. The system of claim 1, wherein the at least one user system includes a relationship management system.

7. The system of claim 6, wherein the relationship management system includes a profile database containing at least one customer profile record.

8. The system of claim 7, wherein the at least one customer profile record includes at least one of a customer priority entry, a desired product entry, a customer feedback entry, and a customer buying pattern entry.

9. The system of claim 7, wherein the relationship management system notifies the user in response to the at least one customer profile record corresponding to at least one product record.

10. The system of claim 7, wherein the relationship management system receives a feedback parameter corresponding to the at least one product record.

11. A method to provide at least one product record for a product to a user, the method comprising:
providing at least one product information entry for the product via the at least one cold chain information source;
receiving the at least one product information entry for the product from the at least one cold chain information source via a processor;
analyzing the at least one product information entry for the product from the at least one cold chain information source via the processor;
assembling the at least one product record from the at least one product information entry via the processor, wherein the at least one product record includes a product fingerprint with a traceability entry;
storing the at least one product record via a product database; and
providing the user access to the at least one product record via at least one user system.

12. The method of claim 11, further comprising identifying a missing product information entry from the at least one product record via the processor.

13. The method of claim 1, wherein the at least one user system includes a relationship management system.

14. The method of claim 13, wherein the relationship management system includes a profile database containing at least one customer profile record.

15. The method of claim 13, further comprising notifying the user in response to the at least one customer profile record corresponding to at least one product record via the relationship management system.
